(19) United States
(12) Patent Application Publication
(10) Pub. No.: US 2023/0015128 A1
(43) Pub. Date: Jan. 19, 2023

(54) System and Method for Reporting Enhanced Toll Road Data to a Toll Road Audit System

(71) Applicant: VeriToll LLC, Ashburn, VA (US)

(72) Inventors: Joseph C. Silva, Las Vegas, NV (US); Miguel A. Calles, La Habra, CA (US); David Ji Kim, Frisco, TX (US)

(21) Appl. No.: 17/867,562

(22) Filed: Jul. 18, 2022

Related U.S. Application Data
(60) Provisional application No. 63/222,895, filed on Jul. 16, 2021.

(51) Int. Cl. G07B 15/06; G06Q 30/04

(52) U.S. Cl. CPC G07B 15/06; G06Q 30/04; G06Q 2240/00

(57) ABSTRACT

A system and a method for reporting enhanced toll road data to a toll road audit system is used to independently audit a toll system including the roadside toll equipment, back-office systems, billing systems, the conditions of the toll road, and other toll variables. The device account associated to a transponder device enters device travel data captured by the transponder device. The device travel data is relayed from the transponder device to the toll road audit server, if the device travel data is entered. The device account enters toll device condition data of a toll road device captured by the transponder device. The toll device condition data is relayed from the transponder device to the toll road audit server, if the toll device condition data is entered. A log entry from the device travel data and the toll device condition data is generated with the toll road audit server.

### FIELD OF THE INVENTION

The present invention generally relates to methodologies for toll road auditing. More specifically, the present invention provides means for the generation and reporting of real-time toll road data to a toll road audit system by utilizing different wireless communication protocols.

### BACKGROUND OF THE INVENTION

In general, roadside toll road equipment includes a variety of devices such as traffic cameras, radio frequency (RF) sensors, pricing signs, etc. The roadside equipment needs to be operational to detect and collect tolls from roadside vehicles. However, the operator may not have efficient means to test/verify/audit the roadside toll systems with traditional mechanisms such as car counting or video auditing to ensure proper operations. Toll road operators could benefit from having an external and independent solution to test and verify status of the roadside toll equipment.

An objective of the present invention is to provide a system and a method to enable independent auditing of roadside toll equipment installed along a toll road. The present invention provides a smart transponder device capable of wirelessly communicating with roadside equipment to audit the operation of the different toll road devices along a toll road. The present invention further provides a smart transponder device equipped with various auditing features that capture the condition of the roadside equipment to provide real-time data about the operational status of the toll road devices along the toll road. The smart transponder device can utilize various travel variables such as velocity, geographical location, and orientation to accurately audit the toll road and the roadside toll equipment. Furthermore, the present invention can be designed to operate with third-party transponders to conduct the auditing of roadside toll equipment. Additional features and benefits of the present invention are further discussed in the sections below.

### SUMMARY OF THE INVENTION

The present invention provides a system and a method for reporting enhanced toll road data to a toll road audit system. The present invention facilitates the auditing of roadside toll equipment from an independent source to provide toll toad operators with accurate data of the operational conditions of different roadside toll equipment along a toll road. In addition, the present invention facilitates the back-office system (BOS) and customer payment operations of toll road operators. To do so, the present invention provides a smart transponder device that is able to capture toll road data that can be relayed to a toll road auditing system for independent auditing of the toll road. Further, the smart transponder device can work along with third-party devices and services to perform the auditing process of roadside toll equipment. The smart transponder device can be mounted within a vehicle and preferably positioned on the vehicle's windshield or rear-view mirror so that the smart transponder device has clear view of the vehicle's surroundings. Device accounts can be rewarded for utilizing the smart transponder device or the smart transponder device can be provided as a replacement for traditional toll transponders.

The auditing process of the present invention involves capturing different real-time device data of the various roadside toll equipment using the smart transponder device. The real-time device data can include, but is not limited to, multimedia data, device telemetry, etc. The real-time device data can be processed locally by the smart transponder device or transmitted to an audit server which processes and analyzes the data to generate the corresponding audit reports. Further, the present invention can utilize different communication protocols to interact with the roadside toll equipment and other external systems. The communication protocols can include, but are not limited to, cellular data, radio frequency (RF) connections, etc. Further, the present invention can pair with external computing devices such as, but not limited to, cellular phones, via the different communication protocols to perform the auditing processes or to utilize the communication capabilities of the external computing devices to enable the independent auditing of the roadside toll equipment. Furthermore, the present invention can provide means to limit the collection of roadside toll equipment data to protect the privacy of the persons using the transponder device. For example, the collection of roadside toll equipment data can be limited to specific geolocations or to events that trigger the operation of the smart transponder device.

### DETAIL DRAWINGS OF THE INVENTION

FIG. 1 is a block diagram for the system of the present invention.

FIG. 2 is a schematic view for a smart transponder device of the present invention.

FIG. 3 is a schematic view for the smart transponder device of the present invention, wherein the smart transponder device is shown mounted onto a vehicle rear-view mirror.

FIG. 4 is a schematic view for an alternate embodiment of the smart transponder device of the present invention.

FIG. 5 is a schematic view for the smart transponder device of the present invention, wherein the smart transponder device is shown wirelessly connected to other computing devices inside a vehicle.

FIG. 6 is a flowchart illustrating the overall process for the method of the present invention.

FIG. 7 is a flowchart illustrating the subprocess of collecting current travel data.

FIG. 8 is a flowchart illustrating the subprocess of performing toll road auditing at target geolocations.

FIG. 9 is a flowchart illustrating the subprocess of capturing multimedia data of roadside toll equipment.

FIG. 10 is a flowchart illustrating the subprocess of targeting roadside toll equipment.

FIG. 11 is a flowchart illustrating the subprocess of pairing the corresponding transponder device with wireless roadside toll equipment.

FIG. 12 is a flowchart illustrating the subprocess of pairing the corresponding transponder device with a vehicle computing device.

FIG. 13 is a flowchart illustrating the subprocess of auditing roadside toll equipment using RF sensors.

FIG. 14 is a flowchart illustrating the subprocess of triggering the operation of the corresponding transponder device when paired to a corresponding driver PC device.

FIG. 15 is a flowchart illustrating the subprocess of updating the transponder toll protocol.

FIG. 16 is a flowchart illustrating the subprocess of facilitating toll billing services with the smart transponder device.

FIG. 17 is a flowchart illustrating the subprocess of coupling third-party toll devices to the smart transponder device.

### DETAIL DESCRIPTIONS OF THE INVENTION

All illustrations of the drawings are for the purpose of describing selected versions of the present invention and are not intended to limit the scope of the present invention.

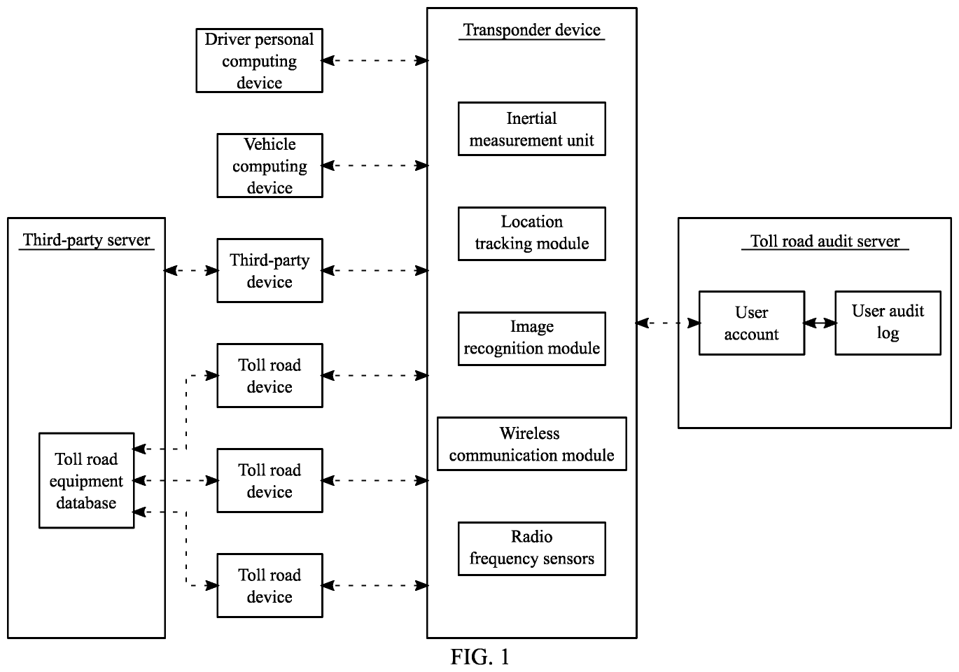

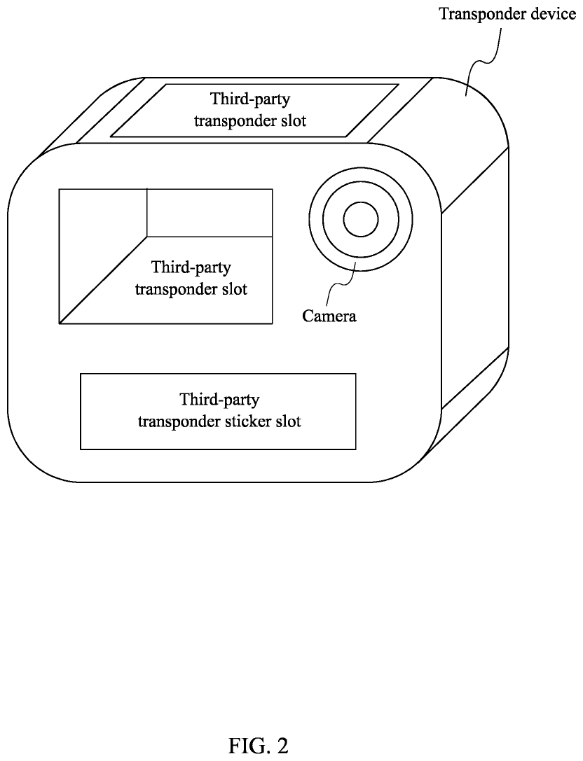

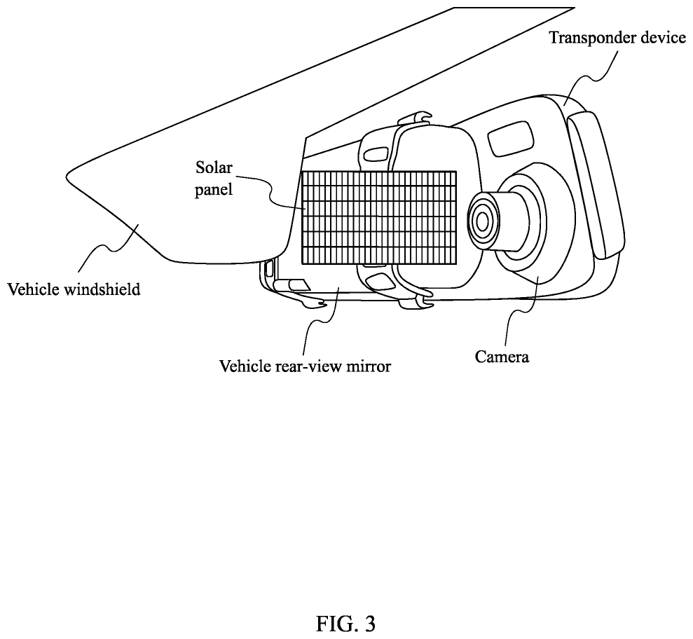

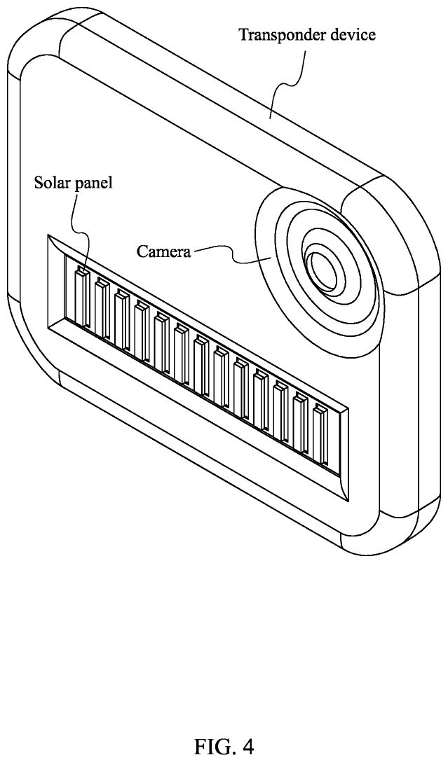

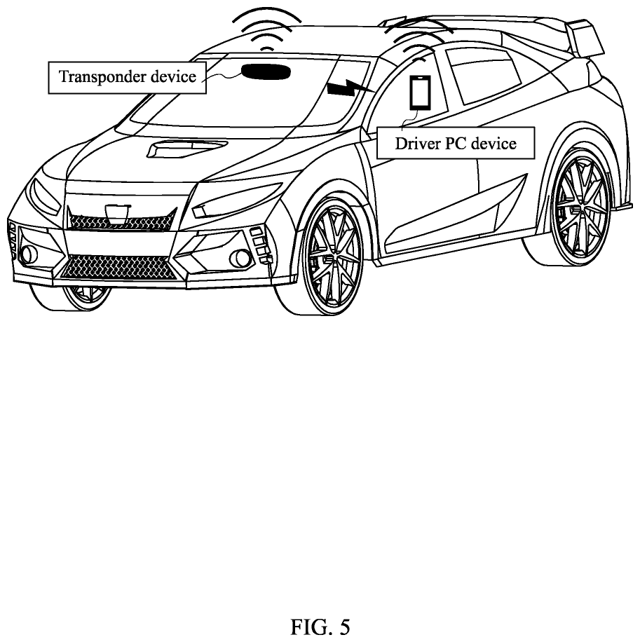

The present invention is a system and a method for reporting enhanced toll road data to a toll road audit system. The present invention enables the independent auditing of roadside toll equipment installed along a toll road to provide accurate real-time operational condition data of the roadside toll equipment. As can be seen in FIG. 1 through 5, to do so, the system of the present invention includes at least one toll road audit server that manages at least one device account managed (Step A). The toll road audit server collects the data provided from the device account to generate audit reports for toll road operators. Data from several device accounts can be processed and analyzed to generate accurate and real-time audit reports that help toll road operators perform necessary maintenance on the roadside toll equipment. Each device account is associated with a corresponding transponder device that facilitates the collection of real-time data regarding the roadside toll equipment. Further, the toll road audit server manages a device audit log for each device account, wherein the device audit log includes a plurality of log entries. The device audit log stores the real-time data of the conditions of the roadside toll equipment and is updated every time a new log entry is generated using new data transmitted from the corresponding transponder device. Furthermore, the system of the present invention includes at least one third-party server that manages a toll road equipment database (Step B). The toll road equipment database provides a repository of current data of the available roadside toll equipment that can be used by the toll road audit server to generate accurate and relevant audit reports. The toll road equipment database is also associated with a plurality of toll road devices that correspond to the roadside toll equipment deployed along the toll road.

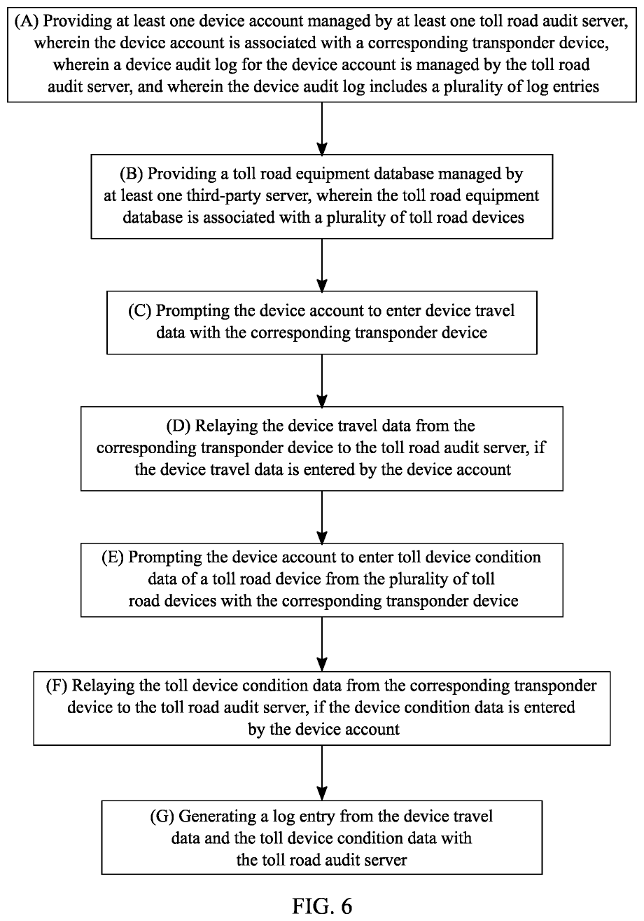

The system of the present invention facilitates the independent auditing of the roadside toll equipment by capturing real-time data of the roadside toll equipment that can be used by the toll road audit server to analyze the current operational conditions of the different toll road devices and generate the appropriate audit reports. As can be seen in FIG. 6, the overall process of the present invention starts by prompting the device account to enter device travel data with the corresponding transponder device (Step C). The device travel data corresponds to data regarding the conditions of the corresponding transponder device and the surroundings such as, but not limited to, current speed and bearing of the vehicle on which the corresponding transponder device is mounted within, geographical position and altitude of the corresponding transponder device, etc. The device travel data is captured by the corresponding transponder device using various smart features equipped to the corresponding transponder device. Then, the device travel data is relayed from the corresponding transponder device to the toll road audit server, if the device travel data is entered by the device account (Step D). The device travel data is relayed to the toll road audit server for processing in order to analyze the data which is to be compared with additional data. In addition, the device account is prompted to enter toll device condition data of a toll road device from the plurality of toll road devices with the corresponding transponder device (Step E). This way, the toll road audit server can also receive real-time data from the roadside toll equipment to assess the operational conditions of the different toll road devices including, but not limited to, the physical state of the roadside toll equipment, toll information displayed by the roadside toll equipment, transponder device data captured by the roadside toll equipment, etc. Like the device travel data, the toll device condition data is captured by the corresponding transponder device using the various smart features of the corresponding transponder device. Then, the toll device condition data is relayed from the corresponding transponder device to the toll road audit server, if the toll device condition data is entered by the device account (Step F). In other words, the captured data from the roadside toll equipment is transmitted from the corresponding transponder device to the toll road audit server. Once all the necessary data has been processed and analyzed by the toll road audit server, a log entry from the device travel data and the toll device condition data is generated with the toll road audit server (Step G). The new log entry is used to update the device audit log which can then be utilized to generate accurate audit reports of the desired toll road by the toll road audit server.

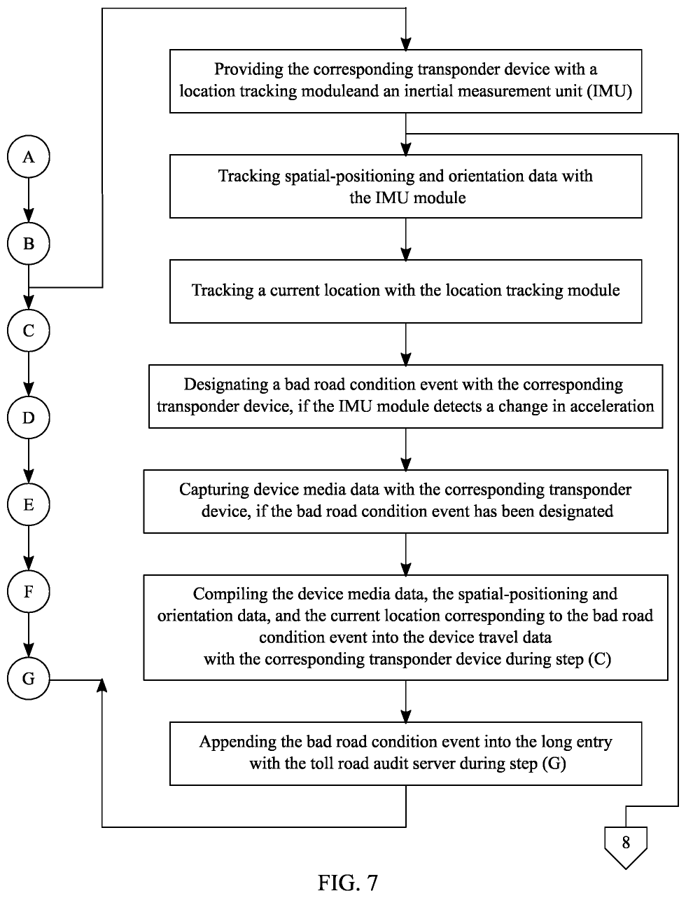

As previously discussed, the device travel data includes various data regarding the status of the corresponding transponder device, the vehicle on which the corresponding transponder device is mounted within, as well as the surroundings of the corresponding transponder device. All this data is utilized to monitor the toll road conditions that can help the toll road operator perform appropriate maintenance. As can be seen in FIG. 7, to do so, the corresponding transponder device is provided with a location tracking module and an inertial measurement unit (IMU). The location tracking module includes various sensors that enable the accurate tracking of the geospatial location of the corresponding transponder device such as, but not limited to, a global positioning system (GPS) receiver. On the other hand, the IMU includes various sensors that enable the accurate tracking of the movement of the corresponding transponder device and the vehicle on which the corresponding transponder device is installed such as, but not limited to, an accelerometer, an altimeter, etc. For example, a sudden shock and a tilt detected by the IMU may suggest the presence of a pothole or other road hazards. Reporting any undesirable road conditions to the toll road operator may lead to faster repairs such that drivers stay encouraged to use the toll road. Together, the IMU and the location tracking module can be utilized to detect events where abnormal road conditions occur while the vehicle is driving along the toll road.

As can be seen in FIG. 7, the subprocess of collecting current travel data includes the steps of tracking spatial-positioning and orientation data with the IMU module. For example, the present invention can track the speed of the vehicle equipped with the corresponding transponder device as well as the moments at which the vehicle accelerates or slows down due to different circumstances such as, but not limited to, traffic, a road hazard, etc. In addition, a current location of the corresponding transponder device is tracked with the location tracking module. Together with the IMU module, the present invention can determine where the vehicle is along the toll road as well as the direction the vehicle is moving towards. Then, a bad road condition event can be designated with the corresponding transponder device, if the IMU module detects a change in acceleration. The bad road condition event can include data regarding different road hazards, such as a pothole, current road work, and other events that affect the normal conditions of the toll road. Once the bad road condition event has been designated by the corresponding transponder device, device media data is captured with the corresponding transponder device to gather visual data regarding the bad road condition event. The corresponding transponder device can be equipped with one or more digital cameras of different capabilities to capture necessary multimedia that can be utilized to analyze the bad road condition event. For example, pictures and/or videos of the bad road condition event can be captured to determine the reason for the event. Once all necessary data of the bad road condition event has been collected, the device media data, the spatial-positioning and orientation data, and the current location corresponding to the bad road condition event is compiled into the device travel data with the corresponding transponder device during the Step C. Then, the bad road condition event is appended into the log entry with the toll road audit server during the Step G. The bad road condition event can include data regarding the bad road event, such as the speed/acceleration of the vehicle, the location of the event, as well as other data collected by other smart features of the corresponding transponder device during the event, such as images and videos of the incident.

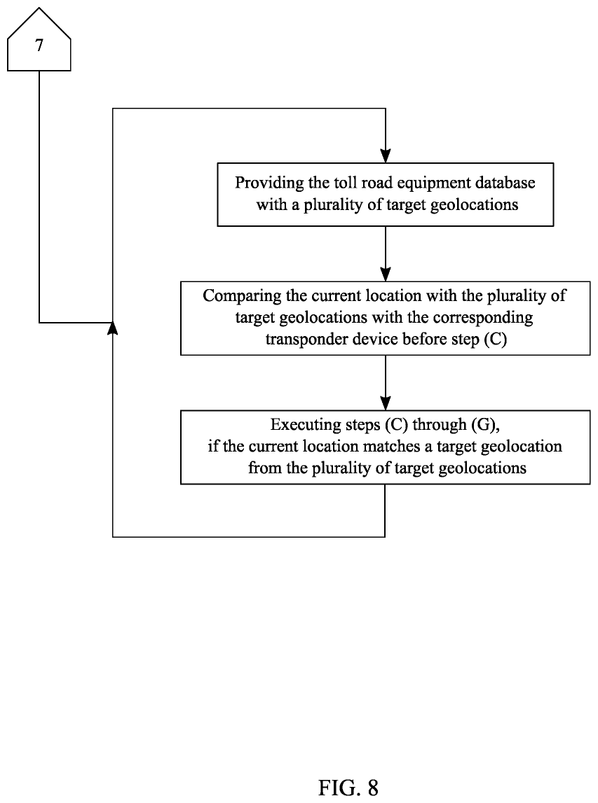

As can be seen in FIG. 8, in addition to helping monitor road conditions, the location tracking module and the IMU can help the present invention protect the privacy of the driver and other passengers of the vehicle. For example, due to the wireless capabilities of the present invention, bad actors may try to obtain unauthorized data from the corresponding transponder device. So, the present invention can prevent such invasion of privacy by only collecting device travel data at predetermined desired locations such as, but not limited to, the locations along the toll road where roadside toll equipment has been installed. To do so, the toll road audit server is provided with a plurality of target geolocations that can correspond to the locations where the roadside toll equipment has been installed. The target geolocations can be obtained from the third-party server managed by the toll road operator or the local jurisdiction. The subprocess of performing toll road auditing at target geolocations includes the steps of comparing the current location with the plurality of target geolocations with the corresponding transponder device before the Step C. For example, as the vehicle moves along the toll road, the location of the vehicle is used to determine if the vehicle is approaching a location where roadside toll equipment has been installed. Then, the Step C through G are executed, if the current location matches a target geolocation from the plurality of target geolocations. This way, the corresponding transponder device does not collect data or relay the collected data to the toll road audit system outside of locations that were preauthorized by the driver, the present invention, the toll operator, the local government, etc. In other embodiments, other methodologies can be utilized to signal the corresponding transponder device to collect and relay data. For example, the corresponding transponder device may also utilize radio frequency (RF) shielding to prevent the transmission of data. The RF shielding may be incorporated as a deployable shield that encloses the transponder component of the corresponding transponder device to block RF signals. Thus, the RF shielding can be deployed when the present invention must not collect roadside toll equipment data and removed at specific geolocations, times, events, etc.

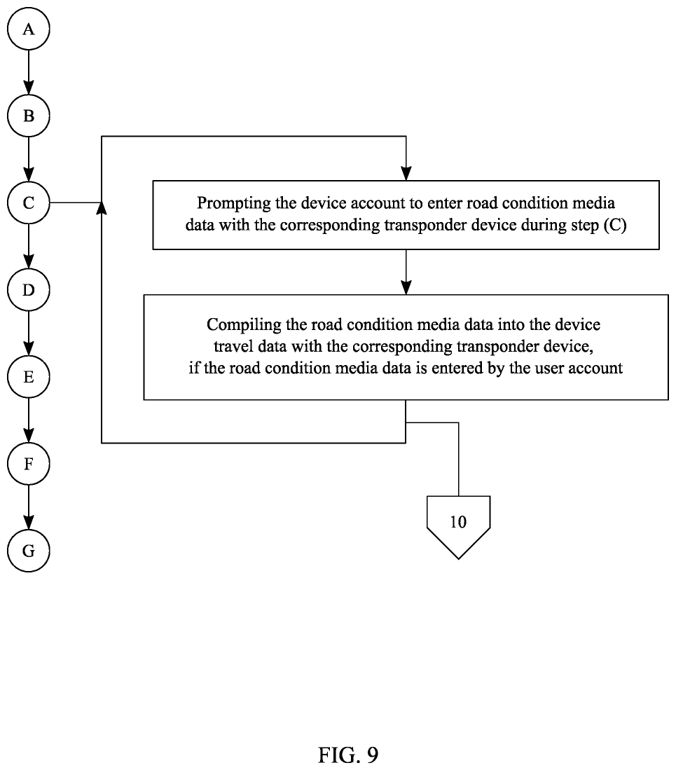

The present invention can be utilized to monitor the condition of various roadside toll equipment that require visual confirmation to determine the status of the different toll road devices. Multimedia data of roadside toll equipment can be used by the toll road operator to maintain the toll road in good condition that are necessarily road hazards. For example, images and videos of the pricing signs can be used to determine if the signs are operating properly as well as to see if the data displayed is correct. Furthermore, the multimedia data can provide data about the road conditions, wear and tear on the toll road devices, etc. As can be seen in FIG. 9, the subprocess of capturing multimedia data of roadside toll equipment includes the steps of prompting the device account to enter road condition media data with the corresponding transponder device during the Step C. The road condition media data can include, but is not limited to, images and/or videos of traffic signs, toll cameras, etc. Then, the road condition media data is compiled into the device travel data with the corresponding transponder device, if the road condition media data is entered by the device account. The road condition media data can then be processed and analyzed by the toll road audit server to generate the appropriate audit reports that can be used by the toll road operator to perform the necessary toll road maintenance.

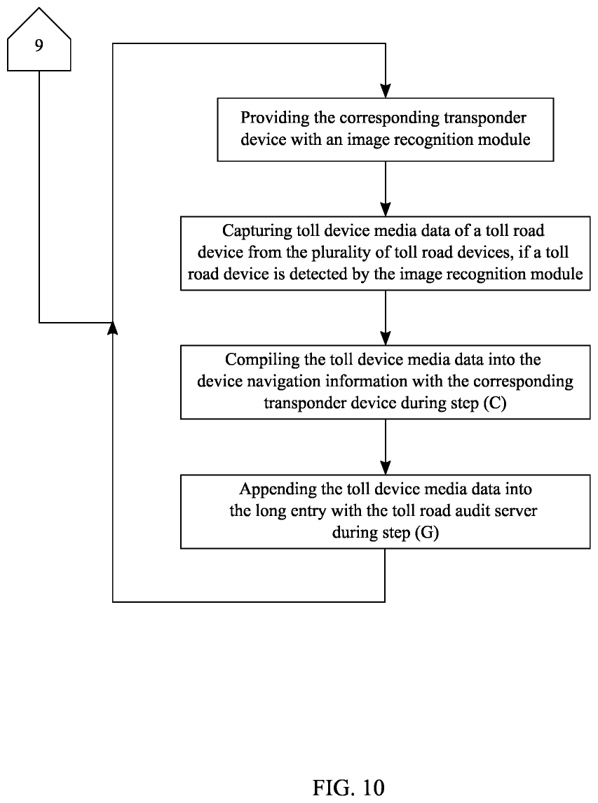

As can be seen in FIG. 10, the present invention can include means to only target the roadside toll equipment in order to capture the necessary multimedia data that can be used to promptly notify the toll road operator of necessary maintenance procedures. To do so, the corresponding transponder device is provided with an image recognition module that helps the corresponding transponder device to target roadside toll equipment. The subprocess of targeting roadside toll equipment includes the steps of capturing toll device media data of a toll road device from the plurality of toll road devices, if a toll road device is detected by the image recognition module. The recognition of the toll road devices can be performed using different image recognition methodologies that help the corresponding transponder device to avoid other objects that are found along the toll road. Data from the toll road operator can be utilized to compare the current status of a toll road device with the desired status of the toll road device as designated by the toll road operator. For example, toll prices can change over time, so the present invention can detect inaccurate prices based on the appropriate prices designated by the toll road operator. Then, the toll device media data is compiled into the device travel data with the corresponding transponder device during the Step C. The toll device media data is then appended into the log entry with the toll road audit server during the Step G. This way, multimedia data of the roadside toll equipment is prioritized instead of continuously capturing all objects that may be found along the toll road.

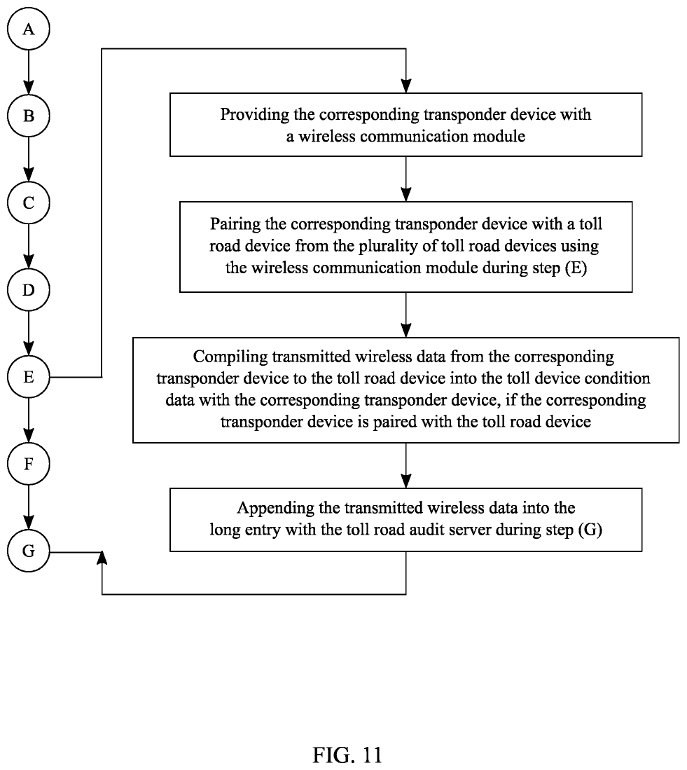

As previously discussed, the present invention is equipped with different means to wirelessly interact with roadside toll equipment and other computing devices as well as to transmit data to the appropriate recipients. The wireless capabilities of the present invention enable the auditing of the wireless roadside toll equipment. As can be seen in FIG. 11, to do so, the corresponding transponder device is provided with a wireless communication module. The wireless communication module includes different communication features that enables the wireless communication between the corresponding transponder device and other computing devices such as, but not limited to, a radio frequency (RF) receiver/transmitter, a cellular data receiver/transmitter, a long-range wide area network (LoRaWAN) receiver/transmitter, a wireless wide area network (WAN) receiver/transmitter, a wireless local area network (LAN) receiver/transmitter, a short-range wireless receiver/transmitter, a personal area network (PAN) receiver/transmitter, etc. The subprocess of pairing the corresponding transponder device with wireless roadside toll equipment includes the steps of pairing the corresponding transponder device with a toll road device from the plurality of toll road devices and/or vehicle RF equipment using the wireless communication module during the Step E. Then, the transmitted wireless data from the corresponding transponder device to the toll road device is compiled into the toll device condition data with the corresponding transponder device, if the corresponding transponder device is paired with the toll road device and/or vehicle. The transmitted wireless data recorded by the corresponding transponder device serves as an independent record of any relevant data captured by the toll road device and/or vehicle. In addition, by sharing the data that was captured by the toll road device, the toll road operator can fix an operational error of the toll road device. For example, the metadata of the corresponding transponder device such as, but not limited to, the media access control (MAC) address, may be useful in deducing a license plate of the vehicle equipped with the corresponding transponder device when the license plate could not be read by the roadside toll equipment. Finally, the transmitted wireless data is appended into the log entry with the toll road audit server during the Step G. This way, all records of the data captured by the roadside toll equipment can be provided in the audit reports.

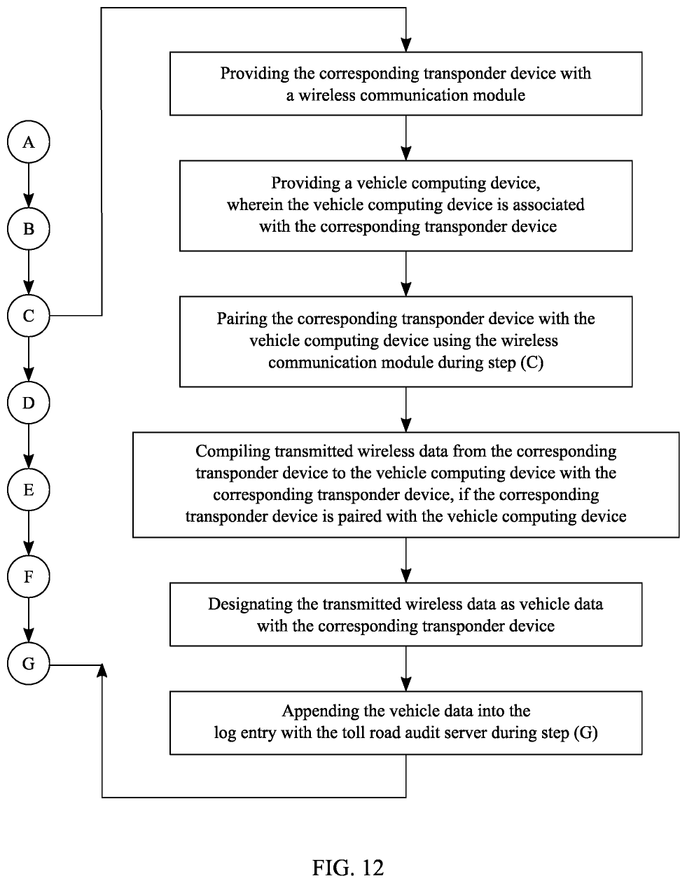

In addition to facilitating the wireless connection with roadside toll equipment, the present invention facilitates the wireless connection with other computing devices for enhanced operation of the corresponding transponder device. For example, the present invention can enable the wireless connection of the corresponding transponder device to vehicle computing device, such as the wireless components of the in-car entertainment (ICE) or the in-vehicle infotainment (IVI) system of the vehicle. This enables the present invention to associate the corresponding transponder device with a specific vehicle for auditing purposes. As can be seen in FIG. 12, the subprocess of connecting the corresponding transponder device to a vehicle computing device includes the steps of pairing the corresponding transponder device with the vehicle computing device using the wireless communication module during the Step C. The driver can perform the pairing using the ICE or IVI systems or through a software application associated with the corresponding transponder device. Then, if the corresponding transponder device is paired with the vehicle computing device, the transmitted wireless data from the vehicle computing device to the corresponding transponder device is compiled with the corresponding transponder device. The transmitted wireless data can include different information regarding the vehicle or the vehicle computing device that helps associate the corresponding transponder device with the vehicle or the vehicle computing device. Then, the transmitted wireless data is designated as vehicle data with the corresponding transponder device. Finally, the vehicle data is appended into the log entry with the toll road audit server during Step G. This way, the toll road audit system can associate the corresponding transponder device with a vehicle or vehicle computing device. This can be used to verify that the corresponding transponder device is being used in a specific vehicle. In addition, the vehicle data can be shared with the third-party server to help the toll road operator accurately assess the activities of the vehicle in the toll road. For example, if the toll system fails to identify the license plate of the vehicle, the vehicle data can be used to determine if the vehicle transmitted through the toll road for billing purposes. In other embodiments, secondary computing devices can be used to associate a vehicle or driver with the corresponding transponder device, such as a smart wearable device, a wireless tracker, a secondary transponder, etc.

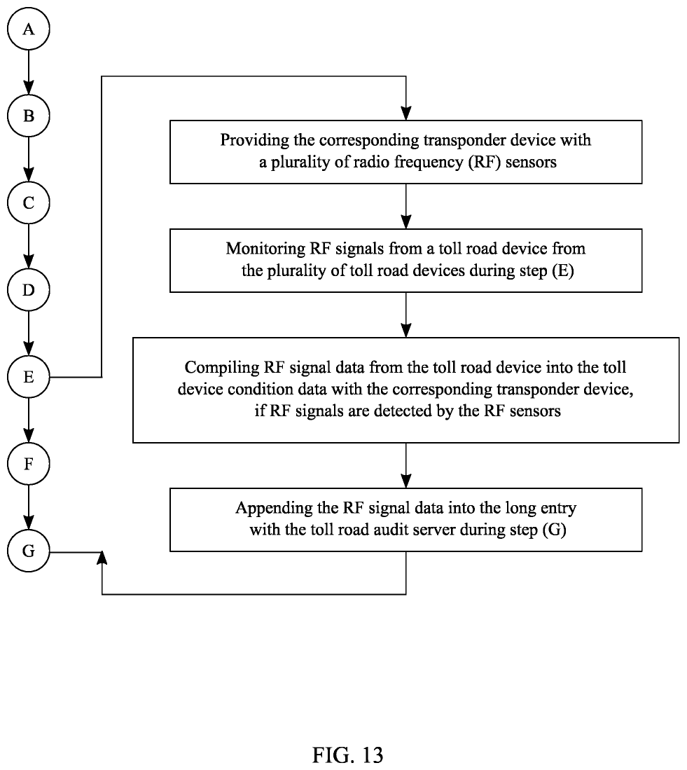

The present invention can also audit the operational conditions of the roadside toll equipment without the corresponding transponder device pairing with the toll road device. The wireless communication module further includes sensors that help monitor wireless signals generated by the roadside toll equipment. As can be seen in FIG. 13, to do so, the corresponding transponder device is further provided with a plurality of radio frequency (RF) sensors. The RF sensors can help determine the status of the roadside toll equipment based on the RF signals generated by the toll road devices. The subprocess of auditing roadside toll equipment using RF sensors includes the steps of monitoring RF signals from a toll road device from the plurality of toll road devices during the Step E. The RF signals generated from the toll road device can be the same signals during the pairing of the devices or other RF signals generated by different roadside toll devices. Then, RF signal data from the toll road device is compiled into the toll device condition data with the corresponding transponder device, if RF signals from the toll road device are detected by the RF sensors. In addition, if the RF sensors fail to detect RF signals from the toll road device, the toll device condition data also includes an alert regarding the failure of detection of RF signals from the toll road device. Finally, the RF signal data is appended into the log entry with the toll road audit server during the Step G. This way, the toll road operator can have the necessary data to determine which toll road devices require maintenance.

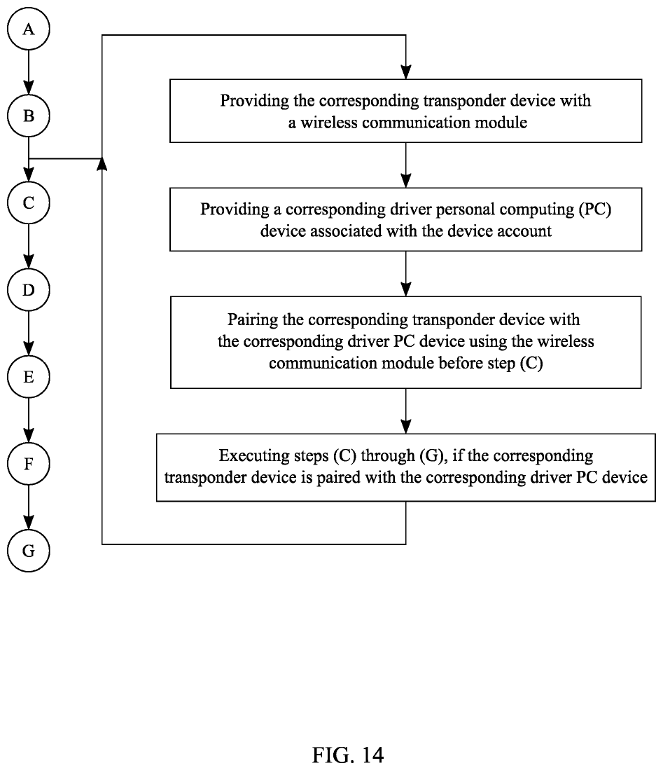

As previously discussed, the present invention can work along third-party computing devices to perform the auditing processes. As can be seen in FIG. 14, the wireless communication module can also be utilized to pair the corresponding transponder device with corresponding driver personal computing (PC) devices of a driver such as, but not limited to, cellular phones, smart wearable devices, third-party auditing devices, etc. In addition, the wireless communication module can help pair the corresponding transponder device with third-party devices such as, but not limited to, third-party transponders provided by the toll-road operator. This way, the corresponding transponder device can work along with existing toll transponders as well as the driver's devices to perform accurate auditing of the roadside toll equipment. For example, the corresponding transponder device can utilize the cameras of the driver's cellular phone to capture multimedia data. The corresponding transponder device can also utilize the location tracking features of the driver's cellular phone to improve the device travel data. Further, the corresponding transponder device can utilize the cellular data of the driver's cellular phone to transmit the collected data to the toll road audit server. Similarly, the corresponding transponder device can utilize the third-party transponder to record the transponder data captured by the roadside toll equipment without the corresponding transponder device pairing with the roadside toll equipment. The corresponding transponder device may include several slots or receptacles design to accommodate third-party transponder devices. Furthermore, each slot or receptacle can include a corresponding RF shield so that the operation of the third-party transponder devices can be limited to desired geolocations, times, events, etc. In other embodiments, the present invention can accommodate other smart devices that enhance the auditing capabilities of the corresponding transponder device.

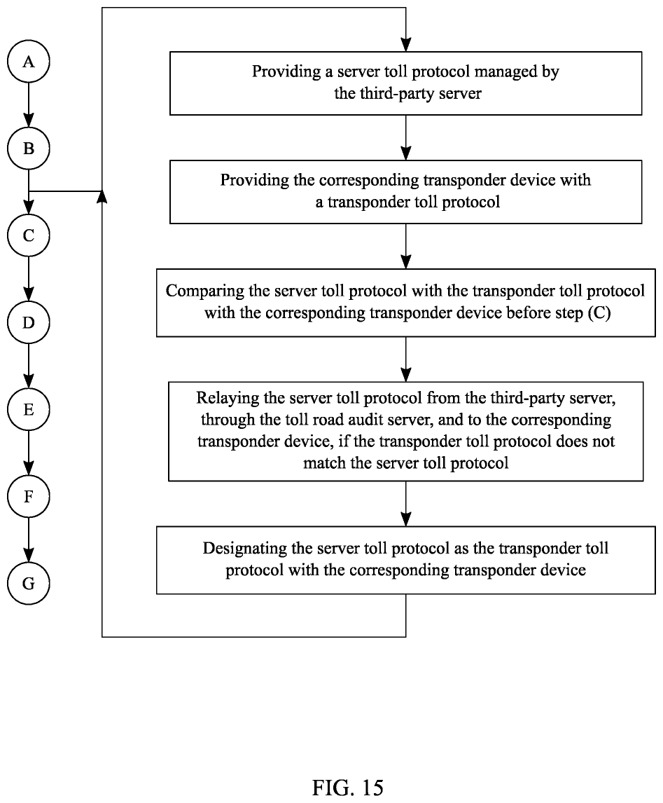

In some embodiments, the corresponding driver PC device can also be used to protect the privacy of the driver. For example, the corresponding transponder device can be configured to collect toll road data only when the corresponding transponder device is paired with a specific corresponding driver PC device. As can be seen in FIG. 15, the subprocess of triggering the operation of the corresponding transponder device when paired to a corresponding driver PC device includes the steps of pairing the corresponding transponder device with the corresponding driver PC device using the wireless communication module before the Step C. Then, executing the Steps C through G, if the corresponding transponder device is paired with the corresponding driver PC device. This way, the corresponding transponder device is activated only if the driver pairs a specific PC device to the corresponding transponder device. Otherwise, the corresponding transponder device does not collect roadside toll equipment data while the driver is away from the vehicle.

As can be seen in FIG. 1 through 5, the corresponding transponder device can be equipped with additional features that enhance the auditing capabilities of the corresponding transponder device. For example, a Graphics Processing Unit (GPU) onboard for Artificial Intelligence (AI) and machine learning local data processing can be provided to process the collected data before sending the data to the toll road audit server for further processing. Further, the corresponding transponder device can include independent power sources so that the corresponding transponder device can operate efficiently. The power sources can include, but are not limited to, replaceable batteries, solar panels, etc. The corresponding transponder device can also include internal storage capabilities so that the device travel data and the toll device condition data can be stored locally until the device travel data and the toll device condition data can be transmitted to the toll road audit server later. This is beneficial in situations where the corresponding transponder device cannot connect to the toll road audit system. For example, the vehicle may be driving through a dead zone or there is a malfunction in the wireless communication module. Furthermore, the corresponding transponder device can include a mount accessory that helps the corresponding transponder device to be securely mounted onto a windshield without obstructing the view of the driver. The mount accessory can also be designed to help mount the corresponding transponder device to other locations or vehicle components such as, but not limited to, the rear-view mirror. Additionally, the present invention may also be configured for non-auditing purposes. For example, the corresponding transponder device may function as a dashboard camera for a driver to utilize as forensic evidence in a vehicle accident.

Furthermore, the present invention can stay updated with newer tolling protocols or adapt to custom protocols as necessary. In other words, the functionality and protocols of the corresponding transponder device can be remotely updated as tolling protocols evolve. Also, if security issues arise in the transponder protocol, the transponder devices can be remotely updated/patched to solve the security problem. As can be seen in FIG. 15, the corresponding transponder device may have transponder toll protocol, while the third-party server may have a server toll protocol that is the most up-to-date protocol. The subprocess of updating the transponder toll protocol includes the steps of comparing the server toll protocol with the transponder toll protocol with the corresponding transponder device before the Step C. Then, the server toll protocol is relayed from the third-party server, through the toll road audit server, and to the corresponding transponder device, if the transponder toll protocol does not match the server toll protocol. Once the server toll protocol has been installed on the corresponding transponder device, the server toll protocol is designated as the transponder toll protocol with the corresponding transponder device. This way, the corresponding transponder device is always updated to work with the desired toll road systems. Lastly, in a situation where a driver does not have the corresponding transponder device accessible to them, the present invention can include a software application that can be run on the corresponding driver PC device. This way, the corresponding driver PC device can be utilized to perform the auditing process without the corresponding transponder device.

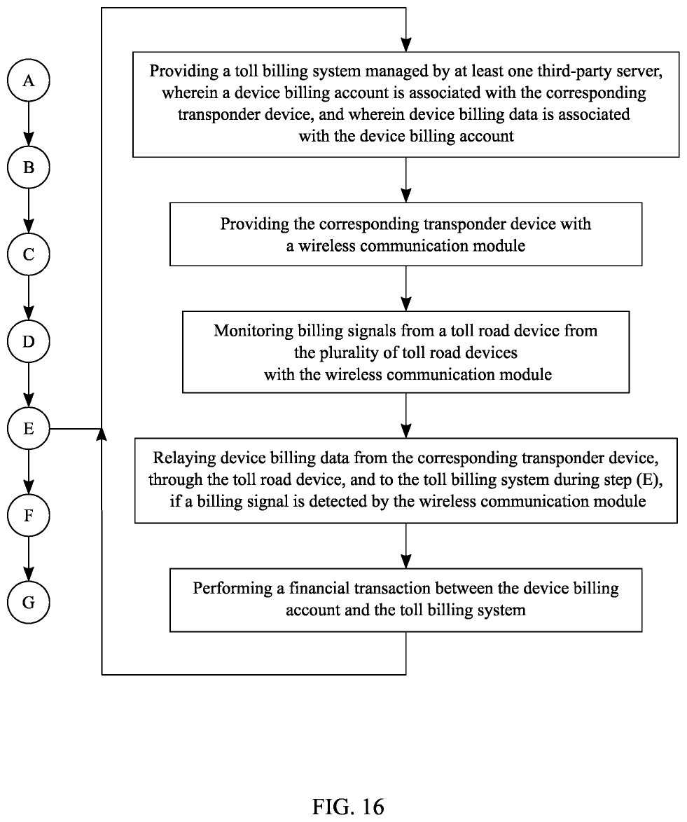

As previously discussed, the corresponding transponder device of the present invention can also perform traditional transponder operations of currently available transponders in addition to the auditing operations. To do so, the present invention can also connect to a toll billing system managed by at least one third-party server. The toll billing system can be part of the established toll system managed by the operator that assigns a device billing account associated with the corresponding transponder device. The device billing account can include device billing data that provides billing information for when the vehicle equipped with the corresponding transponder device utilizes the toll road. As can be seen in FIG. 16, the subprocess of facilitating toll billing services using the corresponding transponder device includes the steps of monitoring billing signals from a toll road device from the plurality of toll road devices with the wireless communication module. This is performed as the vehicle equipped with the corresponding transponder device travels through the toll road. Then, if a billing signal is detected by the wireless communication module, the device billing data is relayed from the corresponding transponder device, through the toll road device, and to the toll billing system during Step E. This way, the device billing information can be confirmed by the toll billing system to charge for the use of the toll road. Then, a financial transaction is performed between the device billing account and the toll billing system which corresponds to the toll fee for using the toll road. In other embodiments, the corresponding transponder device can be equipped with additional features that facilitate other toll-related services.

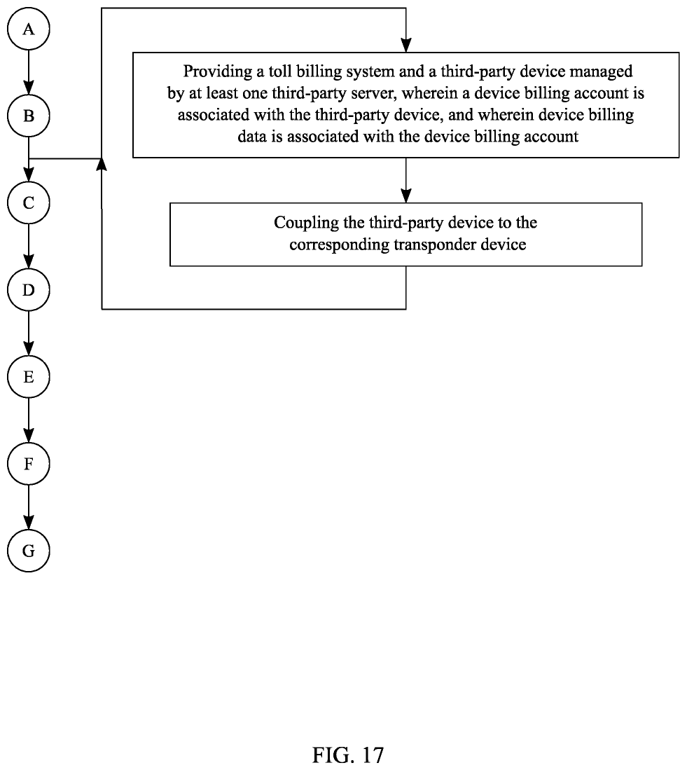

Furthermore, as previously discussed, the present invention can work along with third-party devices provided by the toll-road operator to accommodate existing transponders and other toll devices. The third-party device can include, but is not limited to, third-party transponder devices or third-party transponder stickers that can be affixed to the corresponding transponder device to maintain all toll-related devices together inside the vehicle. To do so, the corresponding transponder device can include different means to hold the third-party device, such as a slot to accommodate the third-party transponder device or sticker. As can be seen in FIG. 17, the subprocess of accommodating third-party devices includes the step of coupling the third-party device to the corresponding transponder device. This can be inserting the third-party device to the appropriate slot in the corresponding transponder device. Then, all billing processes can be performed by the third-party device instead of the corresponding transponder device. The billing processes of the third-party device can be performed independently from the auditing processes of the corresponding transponder device. However, the corresponding transponder device can monitor the operation of the third-party device using the different sensors equipped to the corresponding transponder device such as, but not limited to, the RF sensors. The corresponding transponder device can also capture the data shared between the third-party device and the roadside toll equipment to audit the data being captured by the roadside toll equipment. Further, the corresponding transponder device can control the operation of the third-party device using the RF shielding so that the third-party device can only communicate with the roadside toll equipment during specific times, geographical locations, etc.

Although the invention has been explained in relation to its preferred embodiment, it is to be understood that many other possible modifications and variations can be made without departing from the spirit and scope of the invention.

What is claimed is:

1. A method for reporting enhanced toll road data to a toll road audit system comprising the steps of:
(A) providing at least one device account managed by at least one toll road audit server, wherein the device account is associated with a corresponding transponder device, wherein a device audit log for the device account is managed by the toll road audit server, and wherein the device audit log includes a plurality of log entries;
(B) providing a toll road equipment database managed by at least one third-party server, wherein the toll road equipment database is associated with a plurality of toll road devices;
(C) prompting the device account to enter device travel data with the corresponding transponder device;
(D) relaying the device travel data from the corresponding transponder device to the toll road audit server, if the device travel data is entered by the device account;
(E) prompting the device account to enter toll device condition data of a toll road device from the plurality of toll road devices with the corresponding transponder device;
(F) relaying the toll device condition data from the toll road device, through the corresponding transponder device, and to the toll road audit server, if the device condition data is entered by the device account; and
(G) generating a log entry from the device travel data and the toll device condition data with the toll road audit server.

2. The method as claimed in claim 1 comprising the steps of:
providing the corresponding transponder device with a location tracking module and an inertial measurement unit (IMU);
tracking spatial-positioning and orientation data with the IMU module;
tracking a current location with the location tracking module;
designating a bad road condition event with the corresponding transponder device, if the IMU module detects a change in acceleration;
capturing device media data with the corresponding transponder device, if the bad road condition event has been designated;
compiling the device media data, the spatial-positioning and orientation data, and the current location corresponding to the bad road condition event into the device travel data with the corresponding transponder device during step (C); and
appending the bad road condition event into the log entry with the toll road audit server during step (G).

3. The method as claimed in claim 2 comprising the steps of:
providing the toll road equipment database with a plurality of target geolocations;
comparing the current location with the plurality of target geolocations with the corresponding transponder device before step (C); and
executing steps (C) through (G), if the current location matches a target geolocation from the plurality of target geolocations.

4. The method as claimed in claim 1 comprising the steps of:
prompting the device account to enter road condition media data with the corresponding transponder device during step (C); and
compiling the road condition media data into the device travel data with the corresponding transponder device, if the road condition media data is entered by the device account.

5. The method as claimed in claim 4 comprising the steps of:
providing the corresponding transponder device with an image recognition module;
capturing toll device media data of a toll road device from the plurality of toll road devices, if a toll road device is detected by the image recognition module;
compiling the toll device media data into the device travel data with the corresponding transponder device during step (C); and
appending the toll device media data into the log entry with the toll road audit server during step (G).

6. The method as claimed in claim 1 comprising the steps of:
providing the corresponding transponder device with a wireless communication module;
pairing the corresponding transponder device with a toll road device from the plurality of toll road devices using the wireless communication module during step (E);
compiling transmitted wireless data from the corresponding transponder device to the toll road device into the toll device condition data with the corresponding transponder device, if the corresponding transponder device is paired with the toll road device; and
appending the transmitted wireless data into the log entry with the toll road audit server during step (G).

7. The method as claimed in claim 1 comprising the steps of:
providing the corresponding transponder device with a wireless communication module;
providing a vehicle computing device, wherein the vehicle computing device is associated with the corresponding transponder device;
pairing the corresponding transponder device with the vehicle computing device using the wireless communication module during step (C);
compiling transmitted wireless data from the vehicle computing device to the corresponding transponder device with the corresponding transponder device, if the corresponding transponder device is paired with the vehicle computing device;
designating the transmitted wireless data as vehicle data with the corresponding transponder device; and
appending the vehicle data into the log entry with the toll road audit server during step (G).

8. The method as claimed in claim 1 comprising the steps of:
providing the corresponding transponder device with a plurality of radio frequency (RF) sensors;
monitoring RF signals from a toll road device from the plurality of toll road devices during step (E);
compiling RF signal data from the toll road device into the toll device condition data with the corresponding transponder device, if RF signals are detected by the RF sensors; and
appending the RF signal data into the log entry with the toll road audit server during step (G).

9. The method as claimed in claim 1 comprising the steps of:
providing the corresponding transponder device with a wireless communication module;
providing a corresponding driver personal computer (PC) device associated with the device account;
pairing the corresponding transponder device with the corresponding driver PC device using the wireless communication module before step (C); and
executing steps (C) through (G), if the corresponding transponder device is paired with the corresponding driver PC device.

10. The method as claimed in claim 1 comprising the steps of:
providing a server toll protocol managed by the third-party server;
providing the corresponding transponder device with a transponder toll protocol;
comparing the server toll protocol with the transponder toll protocol with the corresponding transponder device before step (C);
relaying the server toll protocol from the third-party server, through the toll road audit server, and to the corresponding transponder device, if the transponder toll protocol does not match the server toll protocol; and
designating the server toll protocol as the transponder toll protocol with the corresponding transponder device.

11. The method as claimed in claim 1 comprising the steps of:
providing a toll billing system managed by at least one third-party server, wherein a device billing account is associated with the corresponding transponder device, and wherein device billing data is associated with the device billing account;
providing the corresponding transponder device with a wireless communication module;
monitoring billing signals from a toll road device from the plurality of toll road devices with the wireless communication module;
relaying device billing data from the corresponding transponder device, through the toll road device, and to the toll billing system during step (E), if a billing signal is detected by the wireless communication module; and
performing a financial transaction between the device billing account and the toll billing system.

12. The method as claimed in claim 1 comprising the steps of:
providing a toll billing system and a third-party device managed by at least one third-party server, wherein a device billing account is associated with the third-party device, and wherein device billing data is associated with the device billing account; and
coupling the third-party device to the corresponding transponder device.

13. The method as claimed in claim 12, wherein the third-party device is a third-party toll transponder device.

14. The method as claimed in claim 12, wherein the third-party device is a third-party toll transponder sticker.
